(19) United States
(12) Patent Application Publication
(10) Pub. No.: US 2008/0000908 A1
(43) Pub. Date: Jan. 3, 2008

(54) Sealing Arrangement and Process for Hermetic Systems

(75) Inventors: Estevao Marino Espindola, Joinville - Sc (BR); Sthefan Verjas De Almeida, Sao Bernardo Do Campo - Sp (BR); Eriberto Nelson De Souza, Joinville - Sc (BR)

Correspondence Address: DARBY & DARBY P.C., P.O. BOX 770, Church Street Station, New York, NY, 10008-0770, US

(73) Assignee: Whirlpool S.A., Sao Paulo (BR)

(21) Appl. No.: 11/572,763

(22) PCT Filed: Aug. 4, 2005
(86) PCT No.: PCT/BR05/00161

§ 371 Date: Jan. 26, 2007

(51) Int. Cl. F16L 55/11; B21D 41/04; F25B 45/00

(52) U.S. Cl. 220/362; 137/15.01

(57) ABSTRACT

Sealing arrangement and process for hermetic systems of the type which comprises a hermetic shell portion (10), from which outwardly projects a supply tube (20) for supplying a load of working fluid to the inside of the hermetic system and which is subsequently sealed. Said supply tube (20) comprises a first and a second deformation (21, 22) axially spaced apart and each blocking the fluid flow cross section of the supply tube (20); a plug (30) made of a deformable material and which is housed inside the supply tube (20) between the first and the second deformations (21, 22); and at least one intermediary deformation (23) located between the first and the second deformations (21, 22) and deforming a median portion of the plug (30) in order to hermetically block the fluid flow cross section of the supply tube (20) between the first and the second deformations (21, 22).

### FIELD OF THE INVENTION

The present invention refers, in general, to a sealing arrangement for hermetic systems and, more particularly, to those hermetic systems to be supplied with a pressurized fluid and subsequently sealed, such as the refrigeration systems comprising a compressor whose hermetic shell is provided with a refrigerant fluid supply tube, which is hermetically sealed after the refrigeration system has been supplied by the injection of an adequate load of refrigerant fluid.

The invention further refers to a process to carry out the sealing of such type of hermetic system.

### PRIOR ART

In the hermetic refrigeration systems, the compressor is housed inside a hermetic shell portion which is operatively associated with other elements of the refrigeration system, such as a condenser, an evaporator, and a refrigerant fluid flow retaining means, generally a capillary tube, by means of suction and discharge tubes secured through the wall of the hermetic shell portion and which are connected to the elements of the closed refrigeration circuit.

In these refrigeration systems, the supply tube is defined by a metallic tube extension which is welded to the hermetic shell portion of the compressor, projecting outwardly therefrom so as to be connected to the equipments that promote vacuum in the refrigeration system to extract the air contained inside the latter in the final manufacturing phase and which, after air is removed, supplies a load of refrigerant fluid to the interior of the refrigeration system. After injecting the load of refrigerant fluid into the refrigeration system, the supply tube must be sealed to guarantee the tightness for the system during its operational life.

In the hermetic systems in which the working fluid, generally the refrigerant fluid, presents non-inflammable characteristics, the sealing of the supply tube, after the injection of the load of working fluid, is effected by welding the free end of the supply tube.

However, in the hermetic systems in which the working fluid is inflammable, it is not possible to use welding, since this process would put in risk the safety of the operators. In order to solve this limitation, known sealing systems using high frequency or the addition of adhesive metallic pieces usually denominated lock rings, are used. While widely utilized, said sealing systems employing high frequency or the addition of adhesive metallic pieces have a relatively complex and costly construction, unnecessarily increasing the cost of the end product to be commercialized.

### SUMMARY OF THE INVENTION

As a function of the disadvantages mentioned above and related to the systems for sealing the supply tubes of the hermetic systems loaded with an inflammable working fluid, it is an object of the present invention to provide a sealing arrangement for hermetic systems presenting an extremely simple and versatile construction, which can be used both in the hermetic systems containing an inflammable working fluid and in hermetic systems containing a non-inflammable working fluid.

It is a further object of the present invention to provide a sealing process for hermetic systems, such as for example a closed circuit refrigeration system.

According to a first aspect of the invention, the sealing arrangement is applied to hermetic systems of the type which comprises a hermetic shell portion, from which outwardly projects a supply tube for supplying a load of working fluid to the inside of the hermetic system and which is subsequently sealed.

According to the invention, the supply tube comprises a first and a second deformation which are axially spaced apart and each blocking the fluid flow cross section of the supply tube; a plug made of a deformable material and which is housed inside the supply tube in order to occupy, at least substantially, the whole internal volume of the latter defined between the first and the second deformations; and at least one intermediary deformation located between the first and the second deformations and deforming a median portion of the plug in order to hermetically block the fluid flow cross section of the supply tube between the first and the second deformations.

According to another aspect of the invention, there is provided a process for sealing a hermetic system of the type considered above and comprising the steps of:
upon completion of the operation of supplying the working fluid, deforming a first region of the supply tube located at a certain distance from the hermetic shell portion in order to produce therein a first deformation, blocking the fluid flow cross section of the supply tube;
inserting into the supply tube, through an open free end thereof, a plug made of a deformable material;
deforming a second region of the supply tube to produce therein a second deformation over the plug and axially spaced from the first deformation and blocking the fluid flow cross section of the supply tube, said plug occupying, at least substantially, the whole internal volume of the supply tube between the first and the second deformations;
deforming a third region of the supply tube, to produce therein at least one intermediary deformation located between the first and the second deformations and deforming a median portion of the plug, so as to hermetically block the fluid flow cross section of the supply tube between the first an the second deformations.

The sealing arrangement described above is extremely simple and can be carried out by a mechanical squeezing device which is solely shaped and dimensioned to produce the radial deformations of the supply tube that are necessary to hermetically block the fluid flow cross section. The deformation operations do not require application of heat or electricity to the supply tube, allowing the invention to be safely used in hermetic systems containing inflammable working fluids.

It should be understood that the sealing arrangement and process are particularly adequate for sealing the supply tube of the subject sealing system. However, this sealing arrangement can be used for sealing any other hermetic system, even those in which the working fluid is a gas contained inside the system and which needs to be definitely extracted therefrom.

### BRIEF DESCRIPTION OF THE DRAWINGS

The invention will be described below, with reference to the enclosed drawings given by way of example of a preferred embodiment of the invention, and in which:

FIG. 1 is a partial schematic cross-sectional view of a hermetic shell portion of a compressor of a refrigeration system, said hermetic shell portion externally incorporating a supply tube;

FIG. 2 is a similar view to that of FIG. 1, but illustrating the supply tube already provided with the first deformation;

FIG. 3 is a is a similar view to that of FIG. 2, but illustrating a plug extension inserted in the interior of the supply tube;

FIG. 4 is a similar view to that of FIG. 3, but illustrating the supply tube already provided with the second deformation; and

FIG. 5 is a similar view to that of FIG. 4, but illustrating the supply tube already provided with an intermediary deformation and already sealed.

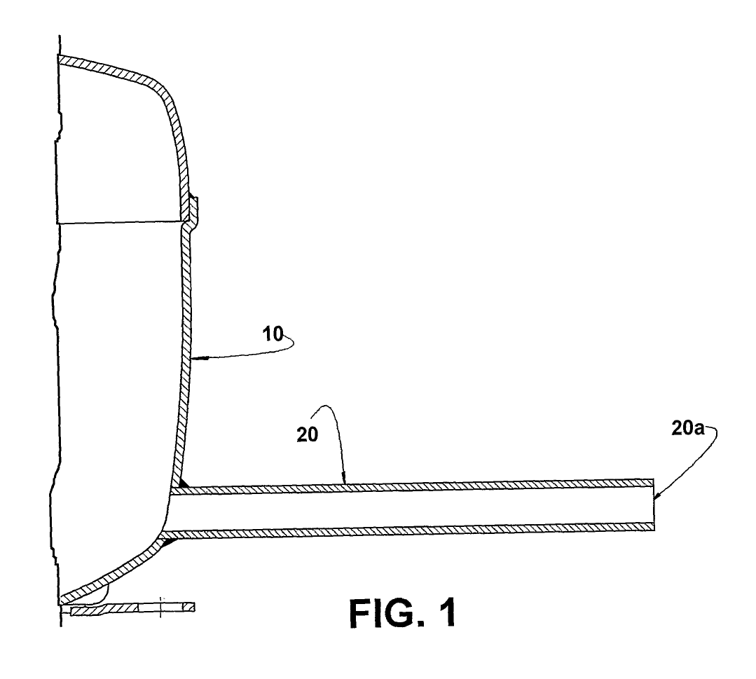

### DETAILED DESCRIPTION OF THE INVENTION

As illustrated in the drawings and described above, the sealing arrangement of the present invention can be applied to several hermetic systems, inside which is injected and hermetically maintained any working fluid which can take the form of a gas or liquid, or even a mixture thereof with phase variations during the operation of the hermetic system. One of the applications of the present sealing arrangement is directed to the closed refrigeration systems, in which circulates a refrigerant fluid to be supplied to the system during the final manufacture phases. As mentioned above, the present arrangement allows the sealing of the hermetic systems to occur independently of the existence of working fluid therewithin.

The present sealing arrangement is therefore particularly applied to hermetic systems of the type which comprises a hermetic shell portion 10, from which outwardly projects a generally metallic supply tube 20 having an extension which is sufficient to allow it to be coupled to means for injecting or extracting a load of working fluid in relation to the interior of the hermetic system, said supply tube 20 being then sealed so as to maintain the working fluid hermetically contained inside the sealing system, which can be a refrigeration system. The fixation of the supply tube 20 to the shell portion 10 can be achieved by any well known adequate method, such as that used to secure the supply tubes projecting outwardly from the shell portion 10 of a refrigeration compressor.

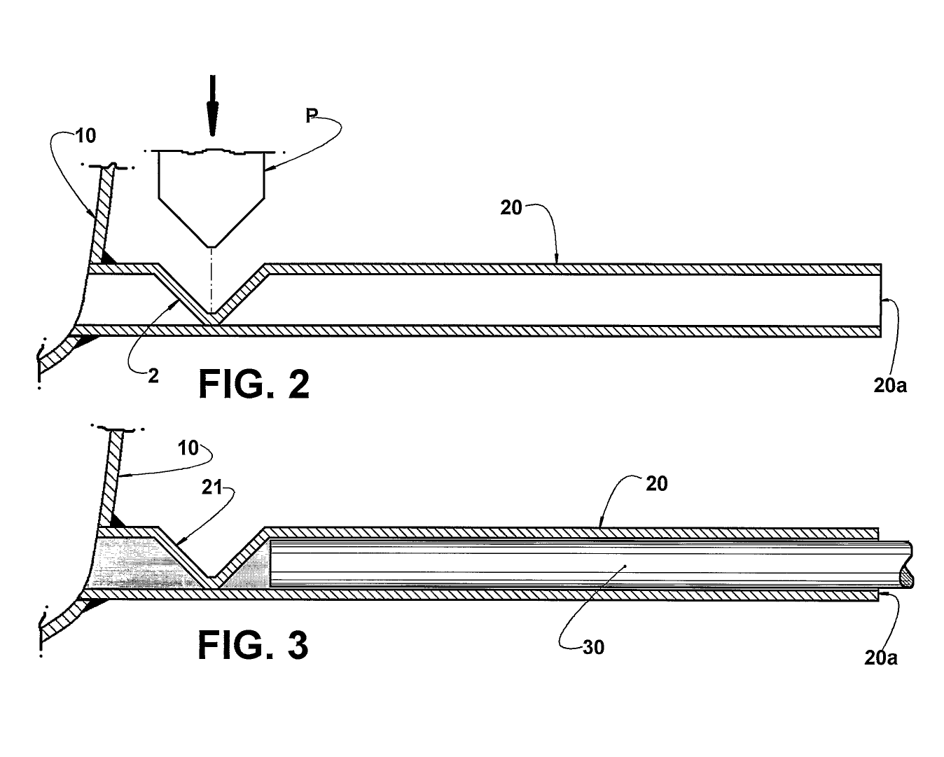

According to the invention, the supply tube 20 is submitted to a first deformation operation, as illustrated in FIG. 2, which is achieved by any adequate device, such as for example a punch “P”, in order to be deformed in a first region at a certain distance from the shell portion 10 and define therein a first deformation 21, blocking the fluid flow cross section of the supply tube 20.

In the illustrated example, the punch P provokes a unilateral radial deformation in the supply tube 20, it being understood however that two or more punches P can be used to produce a first deformation 21 by means of multiple radial deformations exerted on the supply tube 20, said deformations lying on the same plane transversal to the longitudinal axis of the supply tube 20, or on multiple planes transversal to the supply tube 20.

The first deformation 21 can be produced by deforming the supply tube 20 such as to block the fluid flow cross section of the supply tube 20 sufficient to prevent the working fluid, already supplied to the interior of the hermetic system, from leaking substantially through said first deformation 21 upon formation of the latter. However, it is not necessary for the first deformation 21 to produce a perfect and absolute tightness in the supply tube 20, as long as the blocking of the fluid flow cross section of the supply tube 20 is sufficient to assure that any leakage occurring through said first deformation 21 is kept in an irrelevant level while the rest of the sealing operation of the supply tube 20 is being carried out.

Upon completion of the formation of the first deformation 21, a plug 30 made of a deformable material, generally a working fluid resistant elastomer, is introduced into the interior of the supply tube 20 through a free open end 20a thereof.

As illustrated in FIGS. 3 and 4, the plug 30 is usually made of an extension of an elastomeric cord 35 presenting a contour with a cross section which is similar to and slightly inferior to the internal contour of the cross section of the supply tube 20.

Thus, the cord 35 can be introduced into the supply tube 20, as illustrated in FIG. 3, until its inner end is seated against the first deformation 21 or is at least close to the latter. While the plug 30 is preferably formed of a working fluid resistant elastomer, it should be understood that the plug 30 can be made of different non-metallic or even metallic materials presenting a suitable constitution for the formation of a sealing element which can be fitted, by plastic and elastic deformation, in the interior of the supply tube 20 during the sealing operation, as described ahead.

After introducing the cord 35 inside the supply tube 20, the latter is submitted to a second deformation operation in a second region, radially distanced from the one in which the first deformation 21 has been produced and in which a second deformation 22 will be produced on the plug 30, blocking the fluid flow cross section of the supply tube 20.

Upon the formation of the second deformation 22, the plug 30 occupies, at least substantially, the whole internal volume of the supply tube 20 defined between the first and the second deformation 21, 22.

As shown in FIG. 4, the second deformation 22 can also be produced identically as defined for the formation of the first deformation 21, but the second deformation 22 is usually made by deforming the supply tube 20 sufficiently to cut the cord 35, defining more precisely the plug 30 between the first and the second deformations 21, 22.

After the formation of the second deformation 22, the cord 35 is removed from the inside of the supply tube 20, the latter being then submitted to one more deformation operation, similar to those already described in relation to the formation of the first and the second deformations 21, 22 and which is performed on a third region of the supply tube 20, producing in said third region at least one intermediary deformation 23 located between the other two deformations and deforming a median portion of the plug 30, in order to block, hermetically, the fluid flow cross section of the supply tube 20 between the first and the second deformations 21, 22.

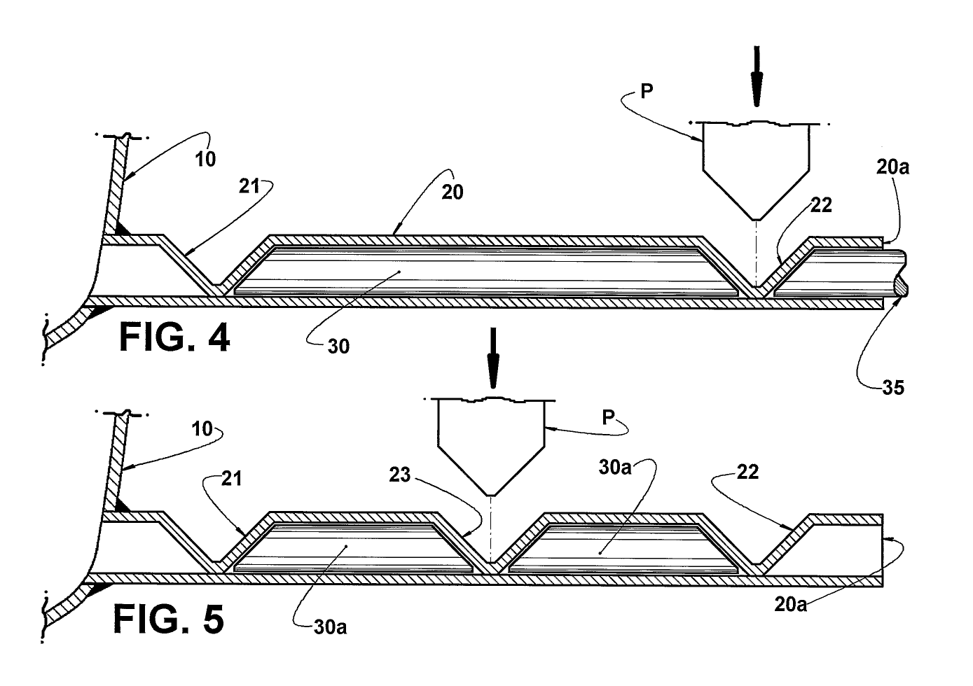

As illustrated in FIG. 5, the intermediary deformation 23 can be made in such a way as to medianly cut the plug 30 in order to form, on each of its axially opposite sides, a respective plug extension 30a which is radially pressed against the supply tube 20 and axially pressed against the adjacent deformations 21, 22, so that each plug extension 30a occupies the whole internal volume of the respective extension of the supply tube 20 in which it remains lodged, guaranteeing a complete and safe tightness for the sealing of the hermetic system.

Even though the deformations responsible for the production of the three deformations are insufficient to guarantee the complete tightness of the supply tube 20, the production of the intermediary deformation 23 deforms the plug 30 so as to press both its opposite portions 30a inside the respective extensions of the supply tube 20, guaranteeing complete tightness for the present sealing arrangement.

While only one preferred construction for the present sealing arrangement has been illustrated herein, it should be understood that alterations in the form and arrangement of the elements are possible without departing from the constructive concept defined in the claims that accompany the present description.

1. A sealing arrangement for hermetic systems of the type which comprises a hermetic shell portion, from which outwardly projects a supply tube for supplying a load of working fluid to the inside of the hermetic system and which is subsequently sealed, wherein the supply tube comprises a first and a second deformation axially spaced apart and each blocking the fluid flow cross section of the supply tube; a plug made of a deformable material and which is housed inside the supply tube in order to occupy, at least substantially, the whole internal volume of the latter defined between the first and the second deformations; and at least one intermediary deformation located between the first and the second deformations and deforming a median portion of the plug (30) in order to hermetically block the fluid flow cross section of the supply tube between the first and the second deformations.

2. Sealing arrangement, according to claim 1, wherein the intermediary deformation forms, on each of its axially opposite sides, a plug extension (30a) which is radially pressed against the supply tube and axially pressed against the adjacent deformations, so that each plug extension occupies the whole internal volume of the respective extension of the supply tube in which it remains lodged.

3. Sealing arrangement, according to claim 1, wherein the plug is made of a working fluid resistant elastomer.

4. Sealing arrangement, according to claim 3, wherein the plug is defined by an extension of an elastomeric cord presenting a contour with a cross section that is similar and slightly inferior to the internal contour of the cross section of the supply tube.

5. Sealing arrangement, according to claim 1, wherein the hermetic system is a refrigeration system whose hermetic shell portion houses the compressor of the system.

6. Sealing arrangement, according to claim 1, wherein the first, the second and the intermediary deformations are each defined by at least one respective radially deformed portion of the supply tube.

7. Sealing process for hermetic systems of the type which comprises a shell portion from which outwardly projects a supply tube for supplying a load of working fluid to the inside of the hermetic system, wherein it comprises the steps of:
upon completion of the operation of supplying the working fluid, deforming a first region of the supply tube located at a certain distance from the hermetic shell portion in order to produce therein a first deformation, blocking the fluid flow cross section of the supply tube;
inserting into the supply tube, through an open free end thereof, a plug made of a deformable material;
deforming a second region of the supply tube to produce therein a second deformation over the plug and axially spaced from the first deformation and blocking the fluid flow cross section of the supply tube, said plug occupying, at least substantially, the whole internal volume of the supply tube between the first and the second deformations;
deforming a third region of the supply tube, to produce therein at least one intermediary deformation located between the first and the second deformations and deforming a median portion of the plug, so as to hermetically block the fluid flow cross section of the supply tube between the first an the second deformation.

8. Sealing process, according to claim 7, wherein the intermediary deformation forms, on each axially opposite sides thereof, a plug extension which is radially pressed against the supply tube and axially pressed against the adjacent deformations, so that each plug extension occupies the whole internal volume of the respective extension of the supply tube in which it remains lodged.

9. Sealing process, according to claim 7, wherein the plug is made of a working fluid resistant elastomer.

10. Sealing process, according to claim 9, wherein the plug is defined by an extension of an elastomeric cord presenting a contour with a cross section that is similar and slightly inferior to the internal contour of the cross section of the supply tube.

11. Sealing process, according to claim 10, wherein the second deformation cuts the cord, separating it from the plug.

12. Sealing process, according to claim 7, wherein the hermetic system is a refrigeration system whose hermetic shell portion houses a compressor of the system.

13. Sealing process, according to claim 7, wherein the first, the second and the intermediary deformations are each defined by at least one respective radially deformed portion of the supply tube.
